(19) United States
(12) Patent Application Publication
(10) Pub. No.: US 2020/0001263 A1
(43) Pub. Date: Jan. 2, 2020

(54) Encapsulation System and Method

(71) Applicants: Cornell University, Ithaca, NY (US); Buckingham Manufacturing Company, Inc., Binghamton, NY (US)

(72) Inventors: Timothy R. Batty, Binghamton, NY (US); Yong Lak Joo, Ithaca, NY (US); Mani Korah, Ithaca, NY (US); Yevgen Zhmayev, Ithaca, NY (US); Mounica Jyothi Divvela, Ithaca, NY (US)

(73) Assignees: Cornell University, Ithaca, NY (US); Buckingham Manufacturing Company, Binghamton, NY (US)

(21) Appl. No.: 16/021,835

(22) Filed: Jun. 28, 2018

(51) Int. Cl. B01J 13/14

(52) U.S. Cl. CPC B01J 13/14

(57) ABSTRACT

An encapsulation system and method including a solution having a first system with a first rate of removal, a second system with a second rate of removal, and a material soluble in the first system, but not soluble in the second system. The first rate of removal is quicker than the second rate of removal, and removal of the first system from the solution creates a concentration of the second system and the material migrates around the second system. Thus, the material creates a shell around the second system, generating a capsule with a shell of the material and a core of the second system. Such material may include a polymer, copolymer, or block copolymer, while the second system is poor solvent for the material, such as hexadecane or Oil Red O. The first system is a good solvent for the material and is readily removable from solution via evaporation during processes like electrospraying.

### BACKGROUND OF THE INVENTION

### 1. Field of Invention

This invention relates generally to encapsulation, more particularly, to micro- and nano-capsule creation by electropraying a tri-phase polymer system.

### 2. Description of the Related Art

Recently, smart polymeric materials have gained significant scientific attention because of their ability to respond to environmental stimuli. The response can trigger functionality of the smart material, such as self-healing, damage sensing, or drug delivery, for example. Polymeric encapsulation techniques can be used to impart the “smart” functionality. The polymer shell protects the functional core (e.g., drugs, indicators, fragrances, chemical precursors) from the normal surroundings. Upon exposure to a stimulus, the shell ruptures and exposes the functional core.

In one example, mechanochromic polymers, smart polymers which change color in response to a mechanical force, have the ability to make considerable improvements in safety. As the mechnochromic polymers can be configured to show a color change in response to a mode of failure, damage can be readily detected. Quick detection of damage has the potential to increase awareness of damaged equipment and improve the efficiency of equipment maintenance. However, the complexity of encapsulation and scalability is a limiting factor for many known techniques.

Therefore, there is a need for a system and method for scalable encapsulation of smart polymeric materials.

### SUMMARY OF THE INVENTION

The present invention recognizes that there are potential problems and/or disadvantages in the above-discussed conventional polymeric encapsulation. In one aspect of the present application, a tri-phase system for nanoencapsulation is provided. The tri-phase system can include a first solvent having a first evaporation rate, a second solvent having a second evaporation rate, and a polymer barrier interacting with the first solvent, and with the second solvent under certain conditions. The first evaporation rate is quicker than the second evaporation rate, such that evaporation of the first solvent creates a concentration of the second solvent and the polymer migrates and precipitates around the second solvent.

In yet another aspect of the present application, a nanoencapsulation system is provided. The nanoencapsulation system includes a solution comprising a first system having a first rate of removal, a second system having a second rate of removal, and a material soluble in the first system, but not soluble in the second system. The first rate of removal is quicker than the second rate of removal, such that removal of the first system from the solution creates a concentration of the second system and the material migrates around the second system.

In another aspect of the present invention, a method for nanoencapsulation is provided. The method includes the steps of: (i) providing a solution with a first system having a first rate of removal, a second system having a second rate of removal, and a material soluble in the first system, but not soluble in the second system; wherein the first rate of removal is quicker than the second rate of removal; (ii) dissolving the material in the first system; (iii) removing the first system from the solution; (iv) generating a concentration of the second system; and (v) moving the material from the first system to around the second system.

Additional features and advantages are realized through the techniques of the present invention. Other embodiments and aspects of the invention are described in detail herein and are considered a part of the claimed invention.

### BRIEF DESCRIPTION OF THE DRAWINGS

The present invention will be more fully understood and appreciated by reading the following Detailed Description in conjunction with the accompanying drawings, in which:

FIG. 1a is a phase diagram of a tri-phase solution system according to an embodiment;

FIG. 1b depicts a flow visualization with a high speed camera of encapsulation using air-controlled electrospray according to an embodiment;

FIG. 1c is a schematic representation of the interaction between solvent 1 with polymer and solvent 2, and resulting shells formed by polymer around droplets of solvent 2 cores;

FIG. 2a is a schematic representations of a conventional electrospray apparatus and a gas assisted electrospray apparatus;

FIG. 2b is a schematic representation of a conventional electrospray apparatus and a gas assisted electrospray apparatus;

FIG. 3a depicts a representative example of scanning electron microscope (SEM) micrographs of one or more droplets having a polymer-encapsulated dye material (unbroken PS capsules), in accordance with one or more aspects of the present invention;

FIG. 3b depicts an aligned nylon nanofiber mat rolled to form a strand upon which the unbroken PS capsules of FIG. 3A were electrosprayed where the strand was subjected to compression and changed color to an intense red color, in accordance with one or more aspects of the present invention;

FIG. 3c depicts a representative example of scanning electron microscope (SEM) micrographs of one or more droplets having a polymer-encapsulated dye material (broken capsules causing a color change), in accordance with one or more aspects of the present invention;

FIG. 4a depicts a representative example of a fluorescent confocal microscope micrograph of one or more droplets having a polymer-encapsulated dye material, in accordance with one or more aspects of the present invention;

FIG. 4b depicts a representative example of a fluorescent confocal microscope micrograph of one or more droplets having a polymer-encapsulated dye material, in accordance with one or more aspects of the present invention;

FIG. 4c depicts a representative example of a fluorescent confocal microscope micrograph of one or more droplets having a polymer-encapsulated dye material, in accordance with one or more aspects of the present invention;

FIG. 5a is an image showing PS/PVDF capsules that were air-controlled electrosprayed between polypropylene electrospun nonwoven mats

FIG. 5b is an image showing PS/PVDF capsules that were air-controlled electrosprayed between polypropylene electrospun nonwoven mats;

FIG. 5c is an image showing PS/PVDF capsules that were air-controlled electrosprayed between polypropylene electrospun nonwoven mats;

FIG. 5d is a graph showing the average optical intensity of liquid dye release from polymer capsules as a result of varying amounts of compressive force;

FIG. 5e is a graph showing the average optical intensity of liquid dye release from polymer capsules as a result of varying amounts of compressive force;

FIG. 5f is a graph showing the average optical intensity of liquid dye release from polymer capsules as a result of varying amounts of compressive force;

FIG. 6a is an additional image showing PS/PVDF capsules that were air-controlled electrosprayed between polypropylene electrospun nonwoven mats;

FIG. 6b is an additional image showing PS/PVDF capsules that were air-controlled electrosprayed between polypropylene electrospun nonwoven mats;

FIG. 6c is an additional image showing PS/PVDF capsules that were air-controlled electrosprayed between polypropylene electrospun nonwoven mats;

FIG. 6d is an additional graph showing the average optical intensity of liquid dye release from polymer capsules as a result of varying amounts of compressive force;

FIG. 6e is an additional graph showing the average optical intensity of liquid dye release from polymer capsules as a result of varying amounts of compressive force;

FIG. 6f is an additional graph showing the average optical intensity of liquid dye release from polymer capsules as a result of varying amounts of compressive force;

FIG. 7a depicts a representative example of a scanning electron microscope (SEM) micrograph of one or more capsules formed from a solution system of PI, P123, and hexadecane;

FIG. 7b depicts a representative example of a scanning electron microscope (SEM) micrograph of one or more capsules formed from a solution system of PI, P123, and hexadecane;

FIG. 7c depicts a representative example of a scanning electron microscope (SEM) micrograph of one or more capsules formed from a solution system of PI, P123, and hexadecane;

FIG. 7d depicts a representative example of q scanning electron microscope (SEM) micrograph of one or more capsules formed from a solution system of PI, P123, and hexadecane;

FIG. 8a depict a representative example of a scanning electron microscope (SEM) micrographs of one or more capsules formed from a solution system of PI and P123;

FIG. 8b depicts a representative example of a scanning electron microscope (SEM) micrograph of one or more capsules formed from a solution system of PI and P123;

FIG. 8c depicts a representative example of a scanning electron microscope (SEM) micrograph of one or more capsules formed from a solution system of PI and P123;

FIG. 8d depicts a representative of a scanning electron microscope (SEM) micrograph of one or more capsules formed from a solution system of PI and P123;

FIG. 8e depicts a representative example of a scanning electron microscope (SEM) micrograph of one or more capsules formed from a solution system of PI and P123;

FIG. 9a depicts a representative example of a scanning electron microscope (SEM) micrograph of one or more capsules formed from a solution system of PI and F68;

FIG. 9b depicts a representative example of a scanning electron microscope (SEM) micrograph of one or more capsules formed from a solution system of PI and F68;

FIG. 9c depicts a representative example of a scanning electron microscope (SEM) micrograph of one or more capsules formed from a solution system of PI and F68;

FIG. 9d depicts a representative example of a scanning electron microscope (SEM) micrograph of one or more capsules formed from a solution system of PI and F68;

FIG. 9e depict a representative of a scanning electron microscope (SEM) micrograph of one or more capsules formed from a solution system of PI and F68;

FIG. 10a depicts a representative example of a scanning electron microscope (SEM) micrograph of one or more capsules formed from a solution system of PI, F108, and hexadecane;

FIG. 10b depicts a representative example of scanning electron microscope (SEM) micrographs of one or more capsules formed from a solution system of PI, F108, and hexadecane;

FIG. 10c depicts a representative example of a scanning electron microscope (SEM) micrograph of one or more capsules formed from a solution system of PI, F108, and hexadecane; and

FIG. 11a depicts a representative example of a scanning electron microscope (SEM) micrographs of one or more capsules formed from a solution system of PI and F108.

FIG. 11b depicts a representative example of a scanning electron microscope (SEM) micrograph of one or more capsules formed from a solution system of PI and F108.

FIG. 11c depicts a representative example of a scanning electron microscope (SEM) micrograph of one or more capsules formed from a solution system of PI and F108.

FIG. 12a depicts a representative example of a scanning electron microscope (SEM) micrograph of one or more capsules formed from a solution system of polyimide;

FIG. 12b depicts a representative example of a scanning electron microscope (SEM) micrograph of one or more capsules formed from a solution system of polyimide;

FIG. 12c depicts a representative example of a scanning electron microscope (SEM) micrograph of one or more capsules formed from a solution system of polyimide;

FIG. 13a depicts a representative example of a scanning electron microscope (SEM) micrograph of one or more capsules formed from a solution system of compressed polyimide;

FIG. 13b depicts a representative example of a scanning electron microscope (SEM) micrograph of one or more capsules formed from a solution system of compressed polyimide;

FIG. 13c depicts a representative example of a scanning electron microscope (SEM) micrograph of one or more capsules formed from a solution system of compressed polyimide;

FIG. 14a depicts a representative example of a scanning electron microscope (SEM) micrograph of one or more capsules formed from a solution system of PI and F68 with hexadecane;

FIG. 14b depicts a representative example of a scanning electron microscope (SEM) micrograph of one or more capsules formed from a solution system of PI and F68 with hexadecane;

FIG. 14c depicts a representative example of a scanning electron microscope (SEM) micrograph of one or more capsules formed from a solution system of PI and F68 with hexadecane;

FIG. 14d depicts a representative example of a scanning electron microscope (SEM) micrograph of one or more capsules formed from a solution system of PI and F68 with hexadecane;

FIG. 14e depicts a representative example of a scanning electron microscope (SEM) micrograph of one or more capsules formed from a solution system of PI and F68 with hexadecane;

FIG. 14f depicts a representative example of a scanning electron microscope (SEM) micrograph of one or more capsules formed from a solution system of PI and F68 with hexadecane;

FIG. 15a depicts on a celguard substrate

FIG. 15b depicts P123 and PI with hexadecane on a celguard substrate;

FIG. 15c depicts P123 and PI without hexadecane on a celguard substrate;

FIG. 15d depicts a representative example of a scanning electron microscope (SEM) micrograph of one or more capsules formed from a solution system of polyimide;

FIG. 15e depicts a representative example of a scanning electron microscope (SEM) micrograph of one or more capsules formed from a solution system of P123 and PI with hexadecane;

FIG. 15f depicts a representative example of a scanning electron microscope (SEM) micrograph of one or more capsules formed from a solution system of P123 and PI without hexadecane;

FIG. 16a depicts polyimide on a celguard substrate;

FIG. 16b depicts F68 and PI with hexadecane on a celguard substrate;

FIG. 16c depicts F68 and PI without hexadecane on a celguard substrate;

FIG. 16d depicts a representative example of a scanning electron microscope (SEM) micrograph of one or more capsules formed from a solution system of polyimide;

FIG. 16e depicts a representative example of a scanning electron microscope (SEM) micrograph of one or more capsules formed from a solution system of F68 and PI with hexadecane;

FIG. 16f depicts a representative example of a scanning electron microscope (SEM) micrograph of one or more capsules formed from a solution system of F68 and PI without hexadecane;

FIG. 17a depicts-polyimide on a celguard substrate;

FIG. 17b depicts F108 and PI with hexadecane on a celguard substrate;

FIG. 17c depicts F108 and PI without hexadecane on a celguard substrate;

FIG. 17d depicts a representative example of a scanning electron microscope (SEM) micrograph of one or more capsules formed from a solution system of polyimide;

FIG. 17e depicts a representative example of a scanning electron microscope (SEM) micrograph of one or more capsules formed from a solution system of F108 and PI with hexadecane;

FIG. 17f depicts a representative example of a scanning electron microscope (SEM) micrograph of one or more capsules formed from a solution system of F108 and PI without hexadecane;

### DETAILED DESCRIPTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

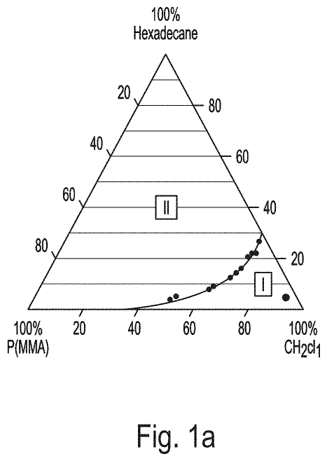

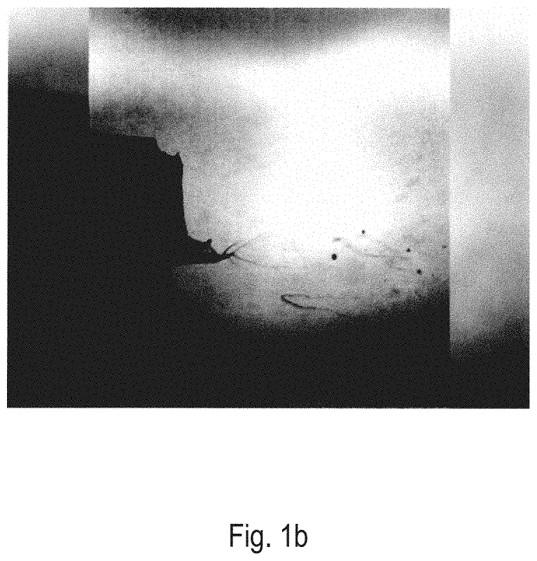

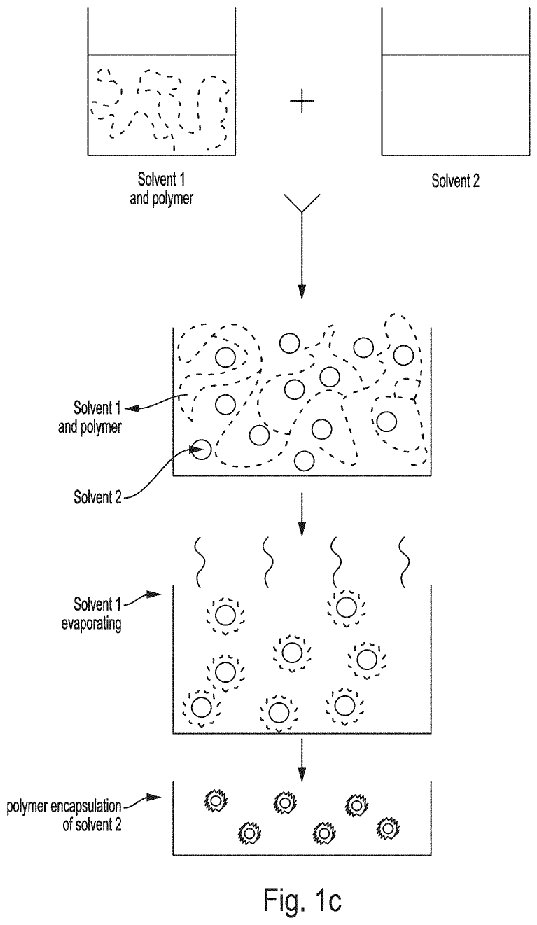

Referring now to FIG. 1, there is shown a phase diagram of a tri-phase solution system according to an embodiment. The solution system is a three component or tri-phase system, including a polymer, a first solvent, and a second solvent. In the depicted embodiment, the polymer is poly methyl methacrylate (P(MMA)) mechanophores (stress-sensitive units); however, a wide variety of polymers can be used. Examples of such polymers may include, among others, polystyrene (PS), poly vinylidine fluoride (PVDF), and poly ethylene oxide (PEO), P123, PI, F68, F108, F88, and PPO.

The first solvent and the second solvent differ in that one is a “good” solvent for the polymer and the other is a “poor” solvent for the polymer. The good solvent evaporates at a rate that is faster than the evaporation rate of the poor solvent. The first solvent is a good solvent for the polymer, such as dichloromethane (DCM), in FIG. 1, or dimethylformamide (DMF), for example. The second solvent is a poor solvent for the polymer, such as hexadecane (in FIG. 1) or a dye such as Oil Red O, for example. The good solvent can be either hydrophilic or hydrophobic, as long as the poor solvent is the opposite. In other words, the good solvent and the poor solvent should preferably be a hydrophobic and hydrophilic pair and the good solvent should preferably be faster evaporating. Although the first solvent and the second solvent differ in how well they dissolve the polymer, the polymer interacts with each solvent better than the solvents react with each other. The polymer interacts with good solvent and poor solvent such that can act as a barrier between the two solvents. The initial tri-phase solution system is in region “I” of the phase diagram of FIG. 1.

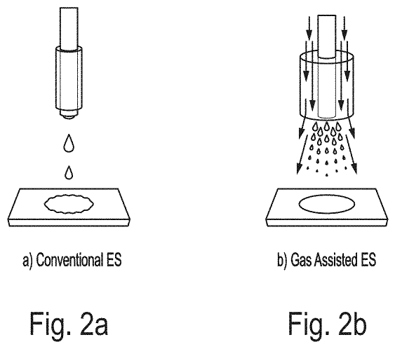

Turning now to FIG. 2, one method to create a micro- or nano-capsule with the solution system is to electrospray the solution system (including the polymer, first solvent, and second solvent). Electrospraying is a well-known, scalable and versatile process in which a polymer solution is ejected into a strong electric field. The electric field atomizes a polymer solution into micro- or nano-droplets to give unique morphologies. The concentration of the polymer solution dictates if the process forms fibers, films, coatings, or particles. Schematics of exemplary embodiments of electrospray apparatuses are shown in FIG. 2.

As shown in FIG. 2, suitable electrospray apparatuses may include a conventional electrospray apparatus, as shown on the left in FIG. 2a, or a gas assisted electrospray apparatus, as shown on the right in FIG. 2b. Reference is made to U.S. Provisional Patent Application Ser. No. 62/466,739 (and its subsequent priority claiming published non-provisional patent application and/or patent), which is incorporated herein by reference as though fully set forth in its entirety, for a more detailed explanation of an air-controlled (i.e., gas assisted) electrospray apparatus, which can be used to electrospray the solution system and create a micro- or nano-capsule. Reference is also made to International Publication No. WO2017083462, which is incorporated herein by reference as though fully set forth in its entirety, for a description of air controlled electrospray manufacturing and products thereof.

In one embodiment, the electrospray apparatus may include an atomizer having a nozzle in the form of a capillary, which is charged to a high electric potential, by a high voltage power supply. The solution system is injected or otherwise inserted into the capillary of the electrospray apparatus. Due to charge accumulation, the solution system forms a Taylor cone. The solution system then atomizes into fine charged droplets, which further subdivide into micro- or nano-scale droplets due to Coulomb fission (i.e., explosion of the original droplet into numerous smaller, more stable droplets), as illustrated in FIG. 2 on the right. While the droplets are monodispersed, the size of the droplets can be precisely controlled by changing process parameters such as voltage, spraying distance, and flow rate, for example.

When the solution system comprising the polymer, first solvent, and second solvent is electrosprayed, atomization in the electrospraying process causes the first solvent (e.g., DCM) to evaporate thereby significantly increasing the concentration of the second solvent (e.g., hexadecane) in a droplet. Consequently, the composition of the solution system starts shifting to region “II” of the phase diagram of FIG. 1, where it exists as a binary phase system. As the second solvent is a poor solvent to the polymer, the polymer migrates to the surface of the second solvent droplet and precipitates as a shell around it (because the polymer is configured to interact with the first and second solvents better than the solvents interact with each other). Thus, the resulting micro- or nano-capsule is comprised of a second solvent core with a polymer shell.

Referring to FIG. 1C, solvent 1 is shown with polymer in a first container, and solvent 2 is shown in a second container. Solvent 1 with polymer is mixed with solvent 2 in a single third container. Solvent 1 is shown evaporating from the third container and the polymer is shown forming shells around droplets of solvent 2 cores.

It is important to note that the tri-phase solution system can form capsules independently of any process or machine if evaporation of the solvents is effectively fast, preferably without getting aggregated into blobs. As shown in FIG. 1B encapsulation occurs with air-controlled electrospray, but has been shown to happen in electrospray without air.

In one embodiment wherein the tri-phase solution system comprises PVDF/PAN, DMF, and hexadecane, the hexadecane is immiscible in DMF. The solution system is emulsified via sonication to yield an oil-in-water emulsion. The hexadecane forms the oil phase and the DMF comprises the water phase. When electrosprayed, the hydrophilic or less hydrophobic phase evaporates, precipitating the PVDF/PAN over the hexadecane.

In another embodiment, a dye is included in the core to make the capsules suitable for damage sensing applications, including safety applications. A dye is added to the initial polymer solution and serves as a stress indicator. If the dye is soluble in both the first solvent and the second solvent, the dye will migrate completely to the second solvent when the first solvent evaporates. In one example, the dye is Oil Red O, which is hydrophobic and migrates completely to hexadecane (i.e., the second solvent) when DCM (i.e., the first solvent) evaporates. Thus, the resulting capsule is a micro- or nano-capsule having a polymer shell formed from PS or PVDF with a core comprised of hexadecane and dissolved Oil Red O, which serves as the damage indicator. Thus, the polymer shell (via electrospraying) can be used to apply a layer of capsules to a surface or embed capsules into fibers. Therefore, when a force reaches or exceeds a threshold level, the capsules rupture and the encapsulated dye is exposed, indicating damage. The threshold level of force can be varied and customized by tuning the polymer shell thickness. This tuning can include increasing the shell thickness in in comparison to the core by decreasing overall capsule size.

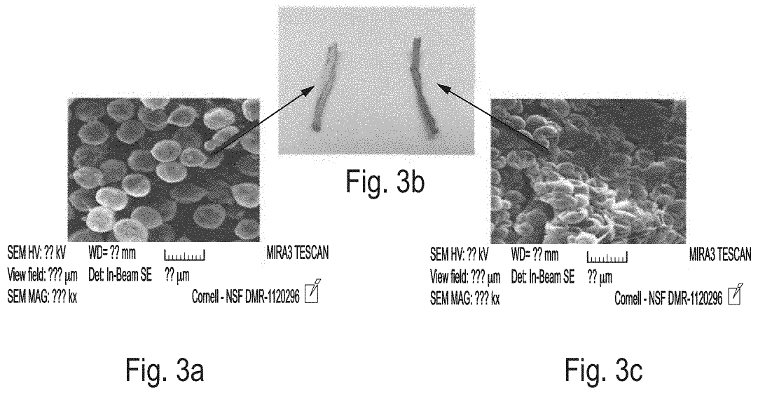

Turning now to FIG. 3, there are shown SEM images of capsules formed upon electrospraying PS, PMMS, PVDF, and PAN capsules. The SEM images demonstrate the color change caused by the rupture of the capsules containing a dye. In the depicted embodiment, unbroken PS capsules (image (a)) are electrosprayed onto an aligned nylon nanofiber mat. The fiber mat was rolled to form a strand (image (b), left). The strand was then subjected to compression and changed color to an intense red color (image (b), right). The resulting broken PS capsules causing the color change are shown in image (c) in FIG. 3.

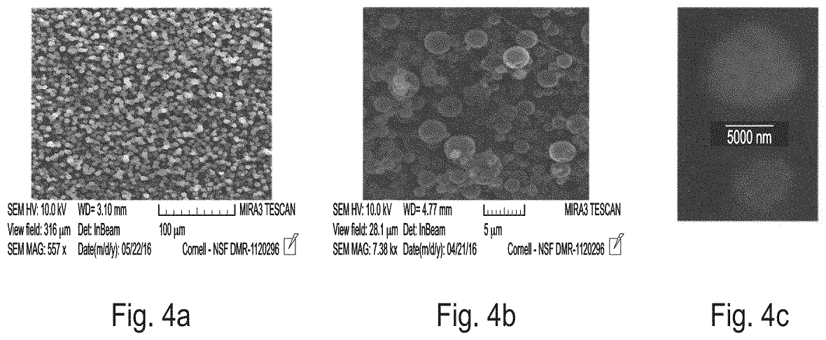

The color change and void nature of the ruptured capsule images in FIG. 3 confirm encapsulation. The ruptured capsules also appear darker, which is most likely due to the Oil Red O and hexadecane. In addition, fluorescent confocal microscopy micrographs of the PS capsules, in FIG. 4, show the Oil Red O uniformly distributed inside the PS shell, further indicating encapsulation.

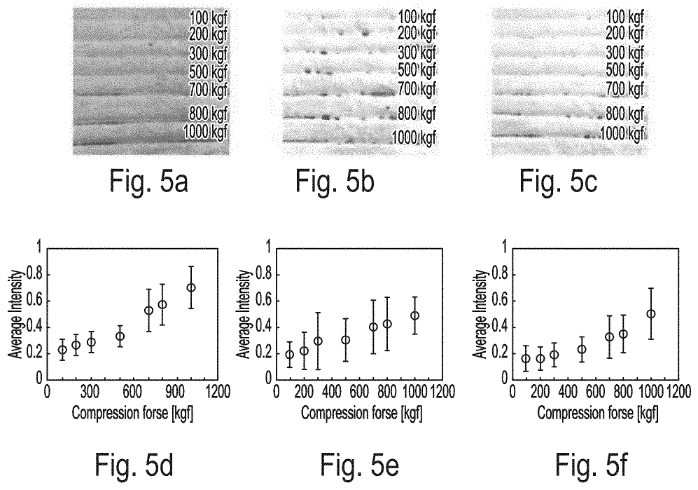

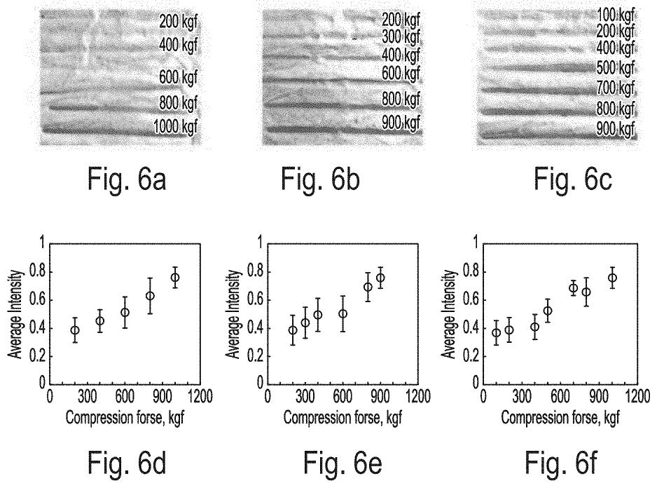

Referring now to FIGS. 5-6, there are shown graphs of the average optical intensity of the liquid dye release from the core of the capsule as a result of varying amounts of compression. In FIGS. 5-6, PS/PVDF capsules were air-controlled electrosprayed between polypropylene electrospun nonwoven mats. The mechanochromic response was quantified using image analysis. An Instron testing machine was then used to apply compressive force between 100-1000 kgf to the ruptured under the compressive force, the liquid dye was released from the core and penetrated the macro-pores of the nonwoven mat, creating a distinct visual indication (i.e., optical response).

In an alternative embodiment, the solution system comprises a polymer that is a copolymer or a block copolymer. In such embodiments, the copolymer has a first portion that interacts with the first solvent and a second portion that does not interact with the second solvent. Stated another way, one portion is hydrophobic and one portion is hydrophilic. Either the first portion or the second portion may be hydrophobic, as long as only one is hydrophobic and the other is hydrophilic.

In an embodiment wherein the polymer is a block copolymer, the block copolymer anchors itself inside the core solvent (i.e., second solvent), thus making it stronger. It increases the strength of the capsule by essentially making the capsule one piece instead of a shell-core system. In one embodiment, the block copolymer may be a poloxamer (e.g., Pluronics), having both hydrophobic legs and hydrophilic legs. The hydrophilic and hydrophobic legs reduce the need for additional hydrophobic and hydrophilic solvents, such as hexadecane. Therefore, the hexadecane (i.e., second solvent) can be eliminated and an oil free core is possible. Examples of such poloxamers are shown in Table 1 below.

TABLE 1
Exemplary Poloxamers

| Pluronics | Chemical Formula |
|---|---|
| P123 | PEO₂₀PPO₆₉PEO₂₀ |
| F68 | PEO₇₆PPO₂₉PEO₇₆ |
| F108 | PEO₁₃₂PPO₅₀PEO₁₃₂ |

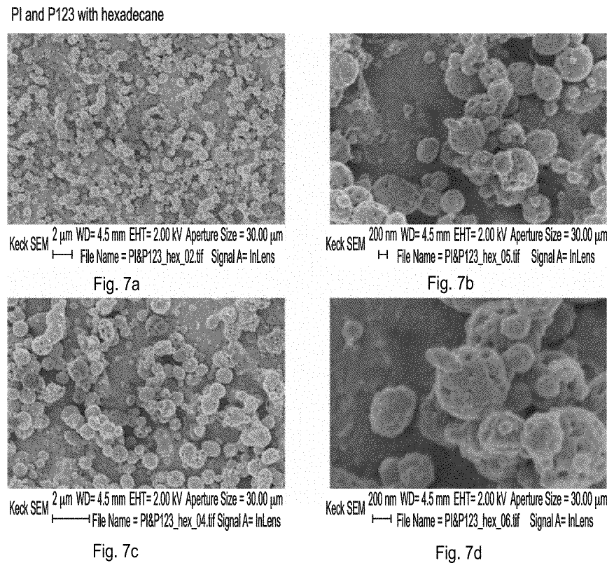

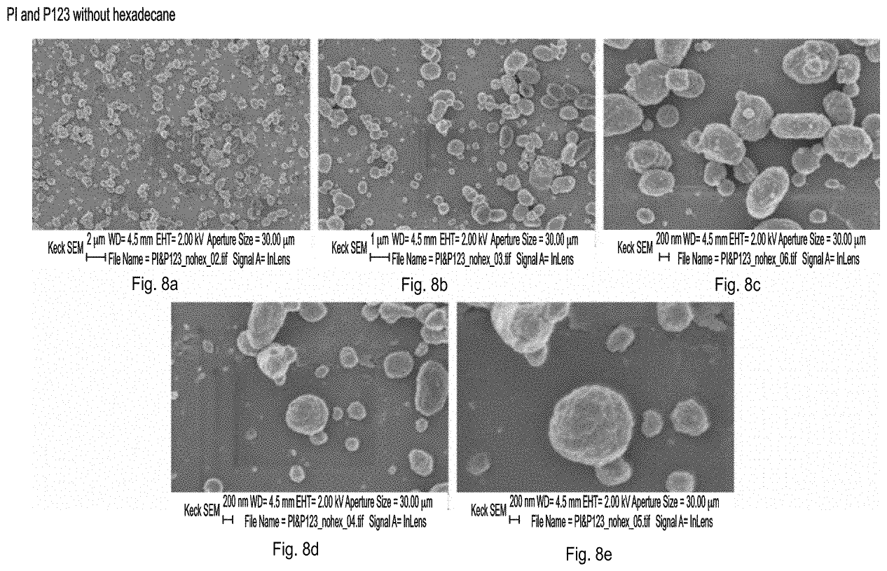

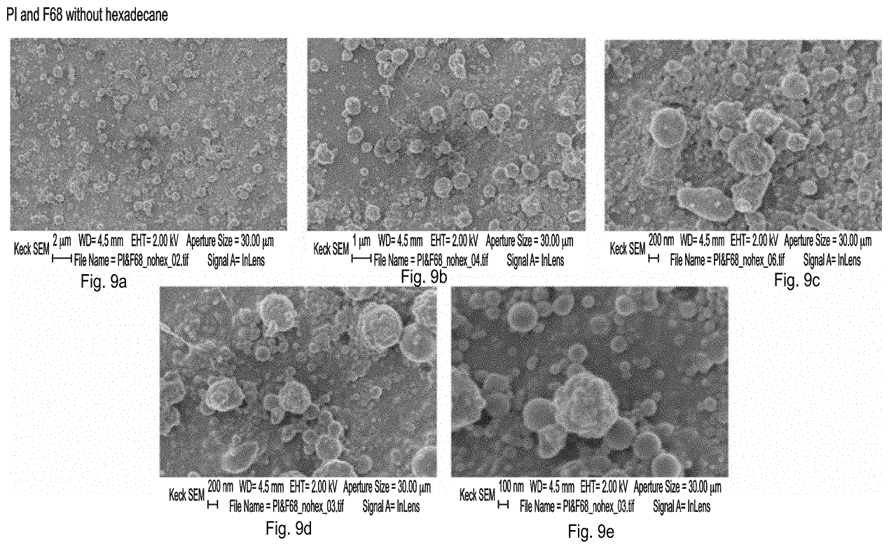

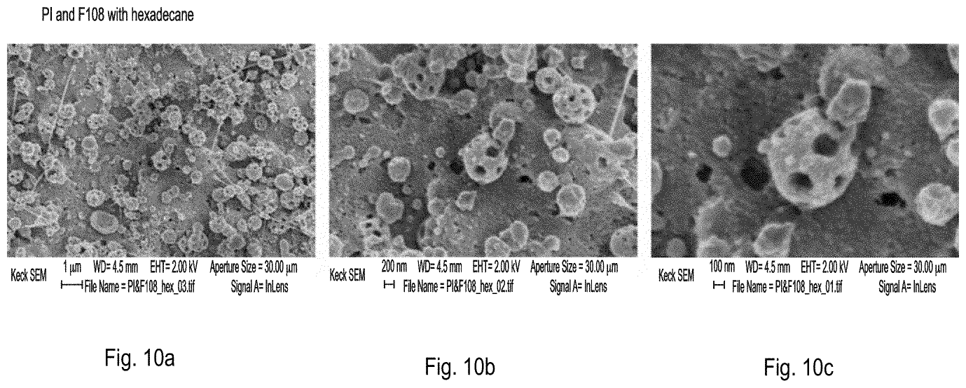

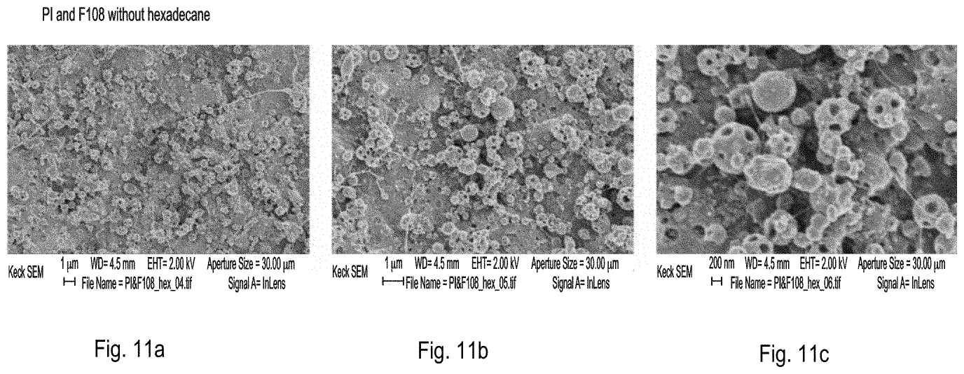

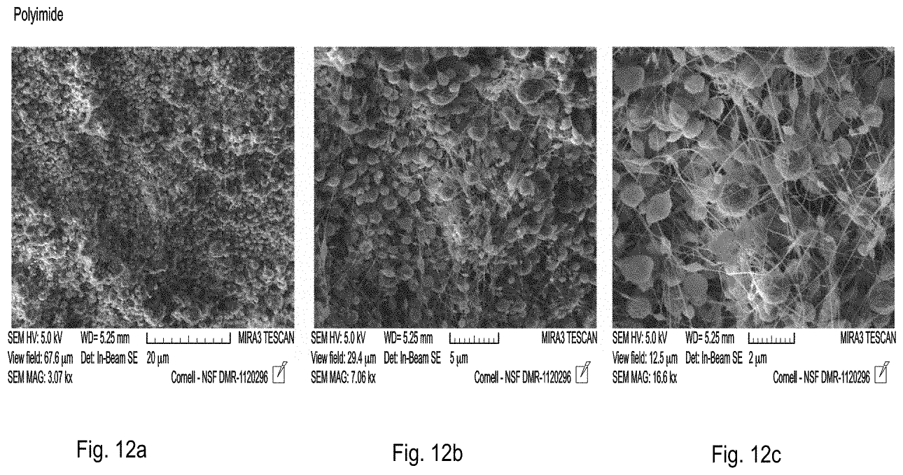

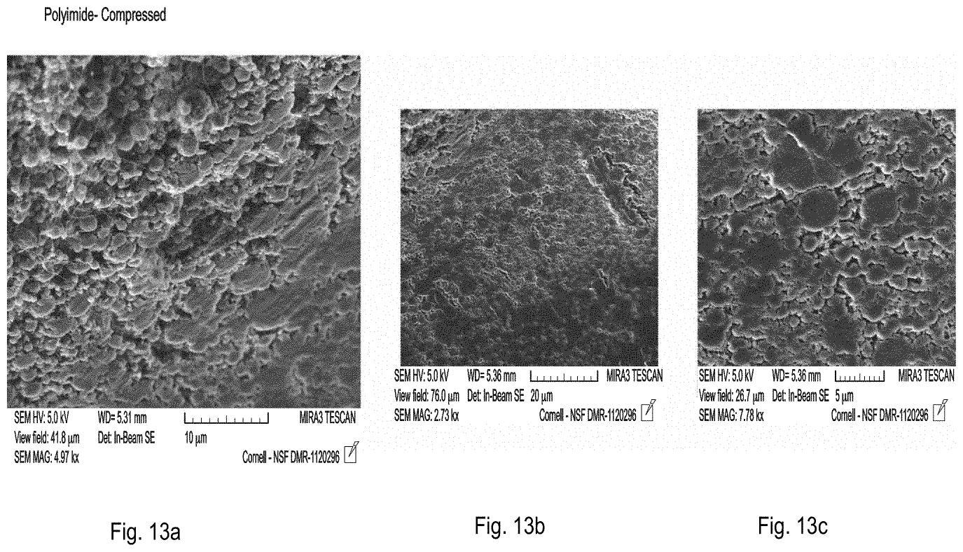

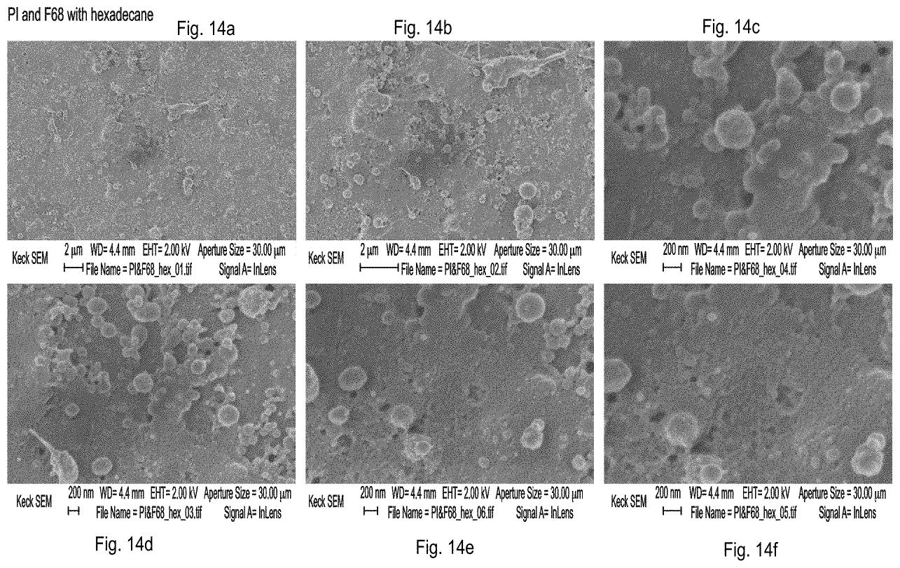

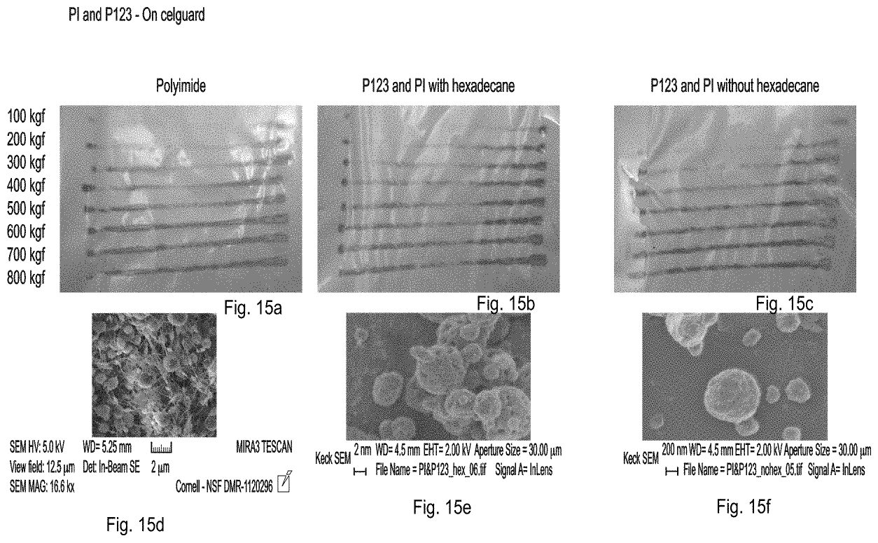

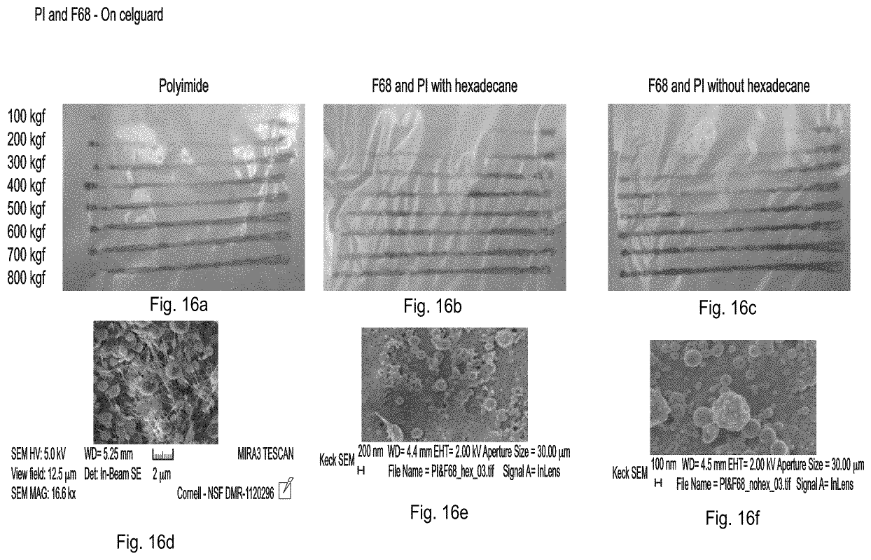

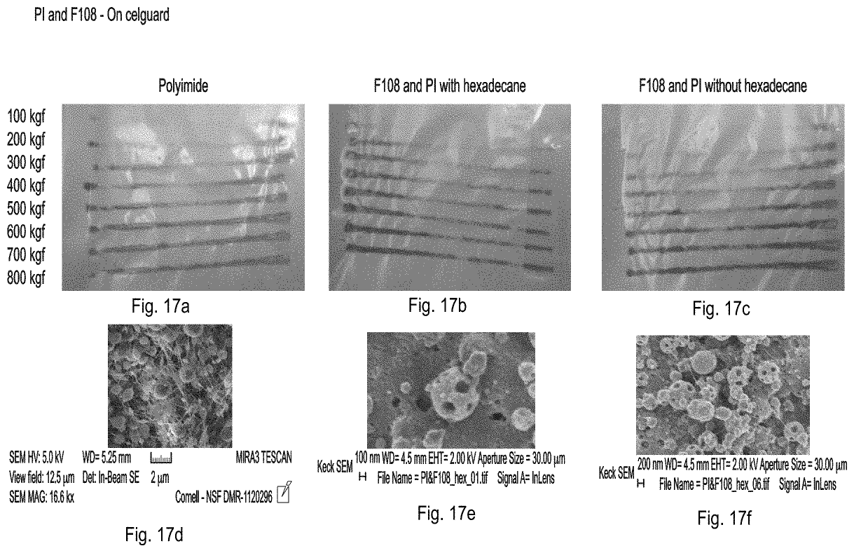

Referring briefly to FIGS. 7-17 there are shown SEM images of capsules formed with polyimide (PI) and the pluronics from Table 1. In FIG. 7 there are shown capsules formed from a tri-phase solution system with PI and P123 with hexadecane. FIG. 8 shows capsules formed from the solution system of FIG. 7 without the hexadecane. Turning now to FIG. 9, there are shown capsules formed from a solution system of PI and F68 without hexadecane. FIGS. 10 and 11 show capsules formed from solution systems of PI and F108 with and without hexadecane, respectively. Further brief descriptions of FIGS. 12-17 are set forth above. In addition to these descriptions, the rupture of capsules after various amounts of compressive force are also shown. In the embodiments wherein the polymer is a poloxamer (e.g., Pluronics, Synperonics, or Kolliphor), mesoporous, microporous, or macroporous capsules (or “porous shells”) can be formed. Thus, the pore size can be within the range of 50 to 200 nm.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

We claim:

1. A tri-phase system for encapsulation, comprising:
a first solvent having a first evaporation rate;
a second solvent having a second evaporation rate;
wherein the first evaporation rate is quicker than the second evaporation rate;
a polymer positioned within the first solvent; and
wherein evaporation of the first solvent results in a formation of an encapsulation by a concentration of the polymer around the second solvent.

2. The tri-phase system of claim 1, wherein one of the first solvent and the second solvent is hydrophilic and the other of the first solvent and the second solvent is hydrophobic.

3. The tri-phase system of claim 1, further comprising a hydrophobic material in the second solvent.

4. The tri-phase system of claim 3, wherein the hydrophobic material is a dye.

5. The tri-phase system of claim 1, wherein evaporation of the first solvent further results in the polymer migrating around the second solvent to form a shell around the second solvent.

6. The tri-phase system of claim 1, wherein the polymer is at least one of: poly methyl methacrylate (PMMA), polystyrene (PS), polyimide (PI), poly vinyl fluoride (PVDF), and poly ethylene oxide (PEO).

7. The tri-phase system of claim 1, wherein the first solvent is at least one of: dichloromethane (DCM), chloroform, Tetrahydrofuran (THF) and dimethylformamide (DMF).

8. The tri-phase system of claim 1, wherein the second solvent is at least one of: hexadecane, paraffin, and decalin.

9. The tri-phase system of claim 1, wherein the size of the encapsulation is between about 100 nm and 5 micron.

10. The tri-phase system of claim 9, wherein the size of the encapsulation is less than 5 micron.

11. The tri-phase system of claim 1, wherein the polymer is a tri-block copolymer.

12. The tri-phase system of claim 11, wherein the tri-block copolymer is a poloxamer.

13. The tri-phase system of claim 1, wherein evaporation of the first solvent further results in a formation of a porous shell of the polymer around the second solvent.

14. An encapsulation system, comprising:
a solution comprising a first system having a first rate of removal, a second system having a second rate of removal, and a material soluble in the first system, wherein the material is not soluble in the second system;
wherein the first rate of removal is quicker than the second rate of removal; and
wherein removal of the first system from the solution creates a concentration of the material around the second system.

15. The encapsulation system of claim 14, wherein the material migrates around the second system forming a shell of the material around the second system.

16. The encapsulation system of claim 14, wherein the material is a polymer.

17. The encapsulation system of claim 14, where one system is hydrophobic and the other is hydrophilic

18. The encapsulation system of claim 14, where there is an active ingredient comprised in the second system.

19. The encapsulation system of claim 18, further comprising a color change indicator in the second system.

20. The encapsulation system of claim 11, wherein the material is a copolymer having a body, a first portion interacting only with the first system, and a second portion only interacting with the second system.

21. The encapsulation system of claim 20, wherein the second portion anchors to the second system.

22. The encapsulation system of claim 20, wherein one of the first portion and the second portion is hydrophilic and the other of the first portion and the second portion is hydrophobic.

23. The encapsulation system of claim 15, wherein removal of the first system from the solution further forms a porous shell of the material around the second system.

24. A method for encapsulation, comprising the steps of:
providing a solution having a first system having a first rate of removal, a second system having a second rate of removal, and a material soluble in the first system, wherein the material is not soluble in the second system;
wherein the first rate of removal is quicker than the second rate of removal;
dissolving the material in the first system;
removing the first system from the solution;
generating a concentration of the second system; and
moving the material from the first system to around the second system.

25. The method of claim 24, further comprising the step of forming a shell comprising the material around the second system.

26. The method of claim 24, wherein the step of removing the first system from the solution comprises the step of evaporating the first system.

27. The method of claim 24, wherein the step of evaporating is accomplished with an electrospray apparatus.

28. The method of claim 27, wherein the step of evaporating the first system with an electrospray apparatus comprises the step of atomizing the solution.

29. The method of claim 24, further comprising the step of dissolving a color change indicator in the second system.

30. The method of claim 24, wherein the second system is hexadecane.

31. The method of claim 24, wherein the step of moving the material from the first system to around the second system further comprising the step of forming a porous shell of the material around the second system.
